(19) United States
(12) Patent Application Publication
(10) Pub. No.: US 2005/0139331 A1
(43) Pub. Date: Jun. 30, 2005

(54) Overhead door apparatus with enclosed counterbalance mechanism

(76) Inventor: James J. O'Malley, Drexel Hill, PA (US)

Correspondence Address: RATNERPRESTIA, P O BOX 980, VALLEY FORGE, PA, 19482-0980, US

(21) Appl. No.: 10/746,903

(22) Filed: Dec. 26, 2003

(51) Int. Cl. E05D 15/16

(52) U.S. Cl. 160/191

(57) ABSTRACT

An integral unit comprising a vertically raisable door of a plurality of sections one being hollow in which is enclosed a counterbalance mechanism provided for counteracting the effect of gravity on the door as it moves from the closed to open position.

### FIELD OF THE INVENTION

The subject invention relates generally to vertically lifted doors, and more specifically to an integral unit comprised of a vertically liftable door having a hollow door section which houses the counterbalance mechanism responsible for counteracting the effect of gravity on the door as it moves from the closed to open position. The device is particularly useful for residences, aircraft hangers, automotive shops, barns, aircraft and blimp hangers, automotive shops, commercial warehouses, military field houses and similar structures.

### BACKGROUND OF THE INVENTION

Liftable overhead doors are not new and are seen frequently in buildings such as homes, aircraft hangers, automotive shops, barns, aircraft and blimp hangers, automotive shops, commercial warehouses, military field houses and similar structures. A wide variety of vertically movable doors are currently used in industrial and other settings. For example, one type of vertically movable door is comprised of a conventional sectional door having of a series of hingedly attached panels with stemmed rollers disposed on opposed lateral edges. Such sectional doors are typically movable between a closed or blocking position and an open or storing position relative to a doorway. For this purpose, a curved guide track is provided on either side of the doorway for receiving the rollers of the panels. The track is comprised of a substantially vertical portion disposed adjacent to the doorway opening, a substantially horizontal portion disposed above and behind the doorway, and an intermediate curved portion interconnecting them on either side of the doorway providing a continuous guide track for receiving the stemmed rollers of the panel sections. In this construction, the door is substantially horizontal when in the open storing position. Another type of vertically movable door is a vertically storable door which moves in a continuous plane between the blocking and storing positions along substantially straight and vertical guide tracks disposed above the doorway opening. In these ways, the mechanical advantage of the lifting force needed to counterbalance the door is recognized to vary and different combinations of lifting devices are used to provide a statically balanced overhead door.

With most vertically movable doors, a counterbalancing device is externally mounted along the guide tracks above the door is provided for counteracting the effect of gravity on the door as it moves between the blocking and storing positions. Such counterbalancing devices typically include a cable system which is attached to the door and a spring which is operatively connected to the cable system. When the door moves from the storing position, the energy stored in the spring becomes stressed and provides a force which counteracts the weight of the door. In this way, the spring controls the descent of the door as it moves towards the doorway-blocking position. Conversely, when the door is raised from the doorway-blocking position, the spring provides a lifting force which makes the door easier to raise. Unfortunately, such mechanisms lack aesthetic appeal and frequently play host to dirt, spider webs and insects which cling to its greased components. It would therefore, be desirable to conceal such mechanisms within the door itself thereby providing a more aesthetically pleasing door assembly having internal components which are substantially free of foreign debris.

U.S. Pat. No. 6,505,381 issued to Thomson on Jan. 14, 2003, teaches pulleys and a cable placed within the body of a folding plane. The '381 invention provides a hinge system for deploying panels or other structures from a satellite or spacecraft. While the '381 patent fits the hinge system within a telescope housing in the deployed position it does not place the entire mechanism within a single element of the deployment panel.

U.S. Pat. No. 5,560,658 issued to Coolman on Oct. 1, 1996, teaches an overhead bi-fold door With the cable and pulley system within the frame of the door. However, it is not enclosed on both sides.

U.S. Pat. No. 6,042,158 issued to Horn on Mar. 28, 2000, teaches a cable actuated locking system inside the body of an overhead door. It does not, however, teach a hollow door panel encasing a counterbalance mechanism.

U.S. Pat. No. 3,774,341 issued to Schoonover on Nov. 27, 1973 and U.S. Pat. No. 4,28,016 issued to Dickson on Mar. 20, 2000, teach cable and spring operating systems for overhead doors that are encased in the frame around the door.

U.S. Pat. No. 1,530,762 to Dautrick issued Mar. 12, 1925, teaches a dual race cable drum having an inner race that spools a cable connected to a tensioning member and a larger outer race with separate cables connected to the door bottom. It does not teach a dual race cable drum to turn about its longitudinal axis perpendicular to its tensioning member axis.

None of the above described inventions teach a vertically liftable door having a counterbalance mechanism enclosed within a panel of the door.

### SUMMARY OF THE INVENTION

In general, the present invention contemplates a vertically acting overhead door system, comprising: a door comprised of at least one hollow door section; said door being moveable between a closed vertical position and an open horizontal position relative to a doorway; and a counterbalance mechanism housed within said at least one hollow door section to facilitate the movement of the door between open and closed positions. The counterbalance mechanism within the hollow door section replaces conventional counterbalance mechanisms associated with vertically raisable doors which are mounted outside of the door either above the door frame or parallel to neighboring guide rails.

More specifically, all embodiments of the subject invention will be comprised generally of a vertically movable door; the door being comprised of at least one hollow door section containing a counterbalance mechanism therein for counteracting the effect of gravity on the door and for controlling the movement of the door between the open and closed positions.

For instance, a first embodiment of the subject invention provides a vertically moveable door comprising at least one hollow door section containing a counterbalance mechanism therein, the counterbalance mechanism being comprised of a tensioning member, cable drums fixed to each end of the tensioning member, a cable spooled around each cable drum, and a plurality of direction transfer pulleys, wherein said cable passes through said direction transfer pulleys and out of the hollow door section to a fixed point adjacent to the door.

In another embodiment of the invention, a vertically moveable door is suspended in a fixed track, said door comprising at least one hollow door section containing a counterbalance mechanism therein, the counterbalance mechanism being comprised of a tensioning member, a plurality of pulleys at least one of which is fixed to the end of the tensioning member, a plurality of cables attached to fixed points within the hollow door panel and running through the pulleys and exiting the sides of the hollow door section to a fixed point adjacent the door.

Accordingly, it is a primary object of the subject invention to provide an integral overhead door unit wherein the counterbalance mechanism is enclosed within the door itself.

Another object of the subject invention is to provide a complete functional counterbalance assembly within the construction of the door itself while using existing track configurations for mounting the door.

It is also an object of the present invention to take advantage of the construction of conventional steel roll formed door sections with a thickness ranging from 2 inches to 6 inches by modifying them to accept this unique counterbalance mechanism without substantial retooling of manufacturing equipment. Further, the invention may be utilized with door sections of greater or lesser thickness through the use of reinforcing members and hardware.

It is another object of the present invention to provide a counterbalance mechanism for vertically moveable doors using a single spring in the body of a door section wherein the spring is free moving and suspended between the door cables and the door itself.

Still another object of the present invention is to provide a counterbalance mechanism for vertically moveable doors using one extension spring or a combination of springs in the body of a door section where the cables pass around a common pulley extending the springs and then to each bottom pulley to a fixed point adjacent the door.

Another object of the present invention is to provide a counterbalance mechanism for vertically moveable doors, said system using a torsion spring assembly inside the body of the door, or a section thereof, said spring assembly effecting the functional counterbalancing of the vertically moveable door.

Yet another object of the present invention is to provide a counterbalance mechanism for vertically moveable doors, said system using torsion springs whereby tension may be applied to the springs by a convenient gear reduction device within the hollow door section and with or without the addition of a drive motor.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 shows a perspective view of the vertically moveable overhead door assembly of the present invention in its closed position, portions of which are depicted in cutaway view to reveal the counterbalance mechanism contained thereof.

FIG. 2 shows a rear view of the vertically moveable overhead door assembly of the present invention with the rear panel removed to reveal a preferred embodiment of the counterbalance mechanism thereof, in this case comprised of an extension spring design.

FIG. 3 shows an alternate embodiment of the counterbalance mechanism of the subject vertically moveable overhead door assembly of the present invention.

FIG. 4 shows a perspective view of the vertically moveable overhead door assembly in its closed position and further showing an alternative fixed spring counterbalance assembly.

FIG. 5 shows a perspective view of yet another embodiment of the vertically moveable overhead door assembly of the subject invention having a freely suspended, spring counterbalance assembly.

FIG. 6 shows a detailed view of the bottom pulley fixture and pivotal idler cam.

### DETAILED DESCRIPTION OF THE INVENTION

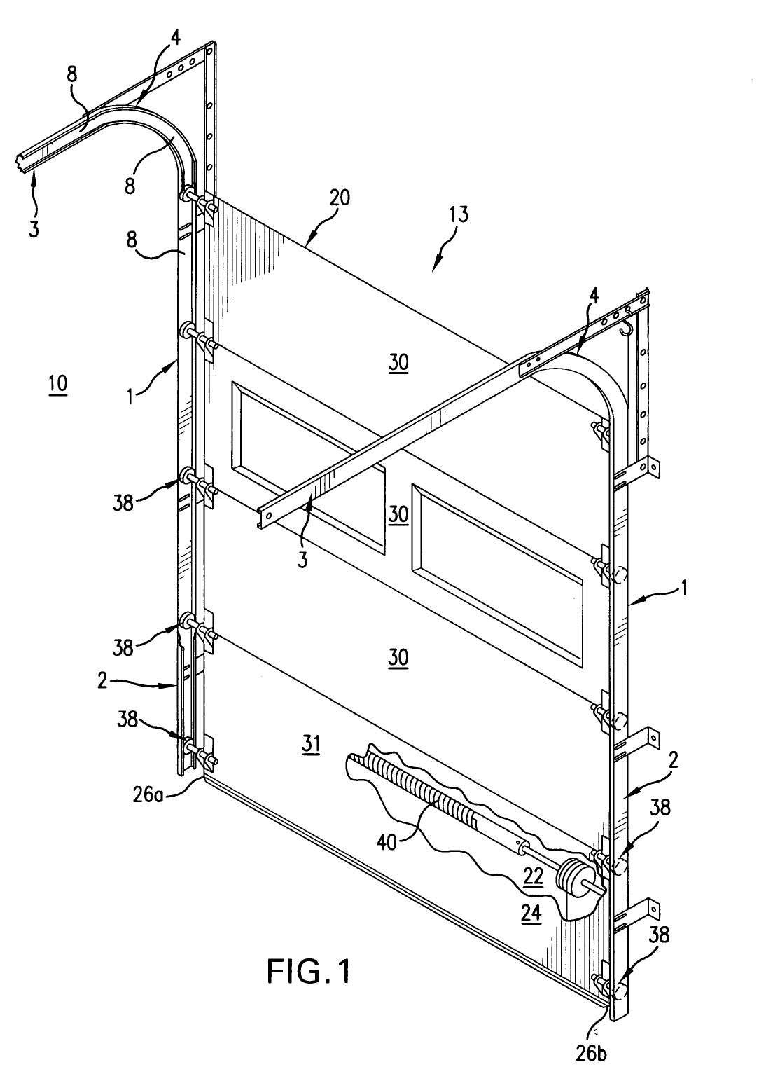

Referring first to FIG. 1, a first embodiment of the subject overhead door assembly is depicted and designated generally by reference numeral 10. The overhead door assemblies 10 of the subject invention are used in residential garage door and commercial overhead door applications, for instance. Each overhead door assembly 10 is an integral unit and includes a vertically moveable door 20 which itself is comprised of at least one hollow door section 31 suitable for enclosing therein the components of a counterbalancing mechanism 40 as described in greater detail below.

Door 20 is also vertically movable relative to a doorway between a closed or blocking position and an open or stowed position. In the illustrated embodiment, door 20 is comprised of a plurality of hingedly attached door sections 30 oriented in series, one on top of another, together with hingedly attached hollow door section 31. As is customary in the art, door 20, or each door section 30 and hollow door section 31, is comprised of a front panel 22, a rear panel 24, and opposed lateral edges 26a, 26b. A plurality of side-mounted guiding elements or lateral end members in the form of rollers 38 are positioned along lateral edges 26a, 26b of door sections 30 and hollow door section 31 for rolling engagement within a pair of guide tracks 1a, 1b mounted on each side of the doorway. In the immediate embodiment, each guide tracks 1a, 1b includes a first segment 2 which extends substantially vertically along the sides of the doorway, a second overhead segment 3 which extends substantially horizontal with respect to the doorway, and a curved segment 4 there between. Each guide track 1a, 1b receives guiding members or rollers 38 of door 20, in a centrally disposed channel 8 which runs at least along the entire length of first segment 2.

Although door 20 described and illustrated in FIG. 1 is comprised of a sectional door having a plurality of hingedly attached door sections 30, it will be readily appreciated by those skilled in the art that door 20 may take other forms without departing from the scope or spirit of the present invention. By way of non-limiting example, door 20 may alternatively be in the form of a single hollow door section (i.e., a non-hinged door structure). It will also be appreciated that the guiding members or rollers 38 for door 20 may take other forms including, for example, pins with rounded heads which are received by guide tracks 1a, 1b. Alternatively, lateral edges 26a, 26b of hingedly attached door sections 30 could form the guiding members by being directly received in the guide tracks 1a, 1b. In addition, the guide tracks 1a, 1b may alternatively be completely straight and vertical, as opposed to curved. In this way, door 20 may either have a substantially horizontal closed position, or a substantially vertical closed position, as with vertically-storable doors.

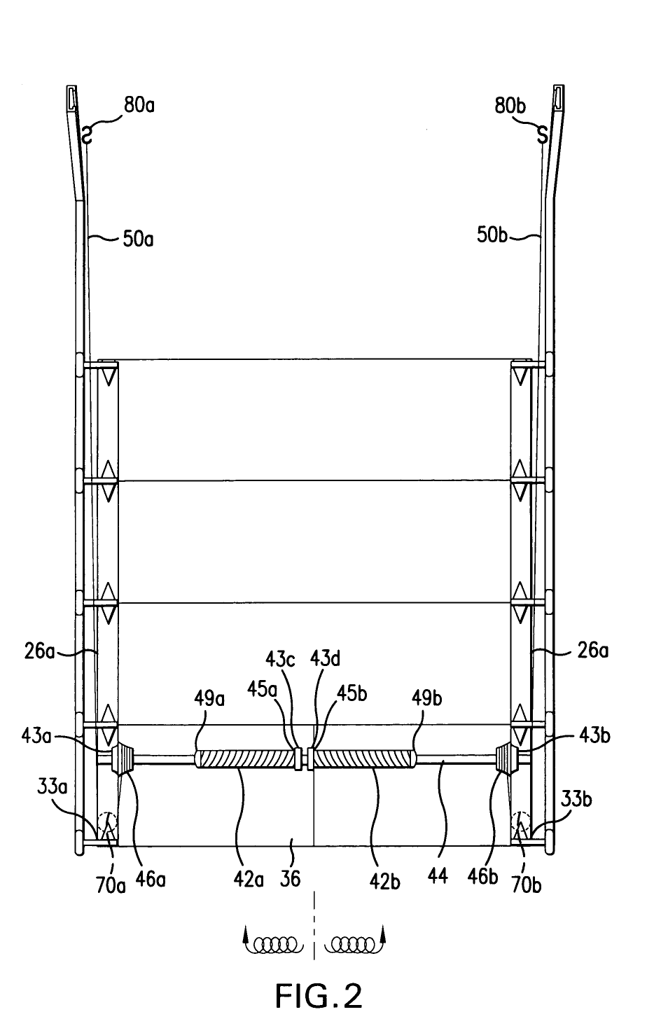

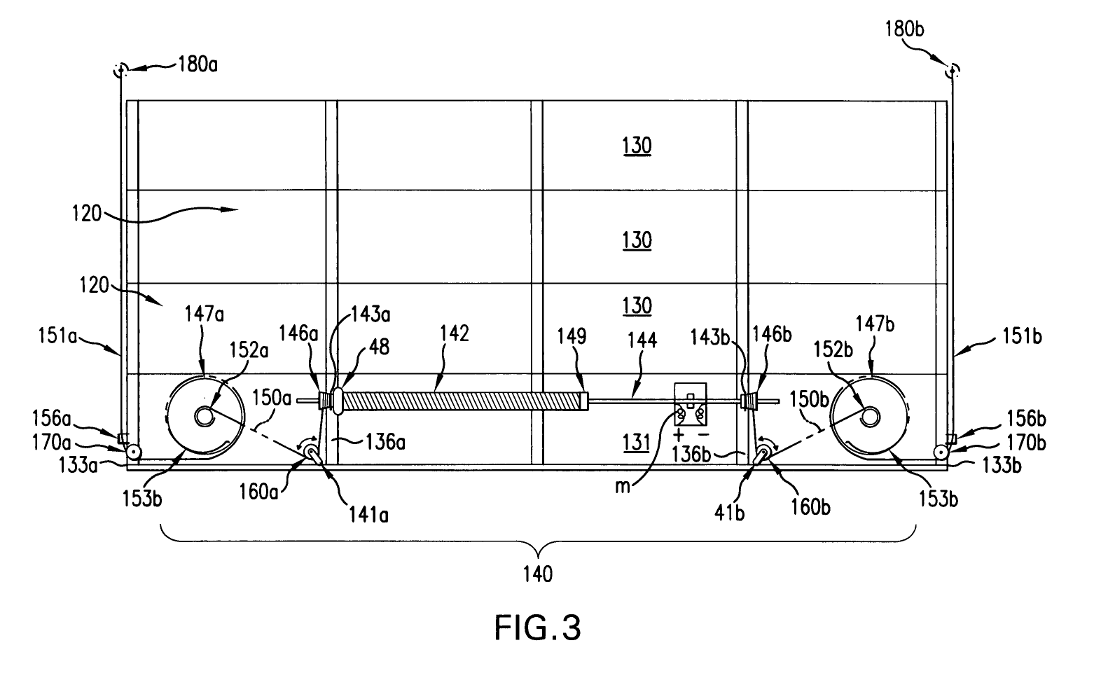

Reference now being made to FIG. 2, counterbalancing mechanism 40 is provided for counteracting the effects of gravity on door 20 as it moves between the open (not shown) and closed positions. Counterbalancing mechanism 40 may be constructed in numerous ways without departing from the spirit of the subject invention which is to house such an assembly inside of the door itself. In a first embodiment, counterbalancing mechanism 40 is comprised of a pair of springs 42a, 42b which are mounted around a support shaft 44, a pair of spaced-apart cable drums 46a,46b which are mounted at opposite ends of support shaft 44, and a pair of tensioning members 50a,50b which in this case take the form of cables. Support shaft 44 is rotatably mounted to door 20 at opposite ends of support shaft 44 by shaft support bearings 43a, 43b. Spring 42 may be a helical torsion spring or other suitable spring or tensioning device known to those skilled in the art. One end of each spring 42a, 42b in relation to other end is fixed onto cone 49a, 49b which is set to the torsion bar. The opposite ends of each spring 42a, 42b terminate in stationary mounting cones 45a, 45b with corresponding shaft support bearings 43c, 43d. As may be appreciated a single spring 42 (FIG. 3) may be substituted for pair of springs 42a, 42b. Support shaft 44 is rotatably mounted within hollow door section 31, and cable drums 46a, 46b are substantially aligned with the opposed lateral edges 26a, 26b of hollow door section 31. In this case, a length of each cable 50a, 50b is wound at one end about its respective cable drum 46a, 46b. Each cable 50a, 50b then extends downward to the lowermost corners of hollow door section 31 where it passes through pulley 70a, 70b and is then redirected out of door 20 through aperture 33a, 33b and upward to a fixed point 80a,80b above the doorway. Although tensioning members 50a, 50b are described herein as cables, it will be appreciated by those skilled in the art that other forms of tensioning members 50a, 50b may alternatively be used including, for example, cords, ropes, belts, chains, and the like.

Thusly described, counterbalancing mechanism 40 not only controls the descent of the door 20 as it moves downwardly from the open position, but also makes the door 20 easier to raise from the closed position. For example, when the door 20 moves towards the closed position, the support shaft 44 rotates about its axis, the tensioning members 50a, 50b progressively unwind from the cable drums 46a, 46b, and springs 42a, 42b (or spring 42) becomes increasingly torsioned. This torsioning of spring 42a, 42b, in turn, causes tensioning members 50a, 50b to exert a force on door 20 which partially counteracts its weight. In this way, counterbalancing mechanism 40 controls the descent of door 20 as it moves either by manual force, motive force, or gravity from the open position. Conversely, when door 20 is lifted from the closed position, the energy stored in springs 42a, 42b provides a restoring force which makes it easier to elevate door 20. In both instances, tension is continuously maintained in tensioning members 50a, 50b as door 20 moves between the open and closed positions. If, however, the tensioning members 50a, 50b were to fail, become slack, or otherwise lose tension, the counterbalancing mechanism 40 would no longer be able to control the upward or downward movement of the door 20.

Although a counterbalancing mechanism 40 with a torsion springs 42a, 42b is specifically shown and described herein, it will be readily appreciated by those skilled in the art that virtually any type of counterbalancing mechanism may alternatively be used-without departing from the scope or spirit of the present invention. For example, the counterbalancing mechanism 40 may instead include extension springs, compression springs, leaf springs, or the like. FIGS. 3, 4 and 5 depict alternate embodiments of counterbalancing mechanism 40 and are described in detail below.

It may be readily appreciated that the diameter of each cable drum 46a, 46b is limited to the depth of hollow door section 31. Accordingly, cable drums 46a, 46b will have a relatively limited capacity. When the gage and/or length of tensioning members 50a, 50b exceed the capacity of their respective cable drums 46a, 46b the addition of intermediate cable spooling apparatus may be employed to resolve this problem as described in detail below. Reference now being made to FIG. 3, an alternate counterbalancing mechanism 140 is provided for counteracting the effects of gravity on door 120 as it moves between the open (not shown) and closed positions. In this next embodiment, counterbalancing mechanism 140 is comprised of a spring 142 which is mounted around a support shaft 144, a pair of spaced-apart cable drums 142a, 142b which are mounted at opposite ends of support shaft 144, and a pair of tensioning members 150a, 150b which in this case take the form of cables. Spring 142 may be a helical torsion spring or other suitable spring or tensioning device known to those skilled in the art. Further, spring 142 may be comprised of a pair of springs (not shown) which are mounted around support shaft 144 as arranged in FIG. 2 above. Gear reduction device 148 may be used to apply tension to spring 142 (or springs 142a, 142b) by rotating one end of spring 142 in relation to its opposite end which is fixed onto cone 149 which in turn is fixed to support shaft 144.

Support shaft 144 is rotatably mounted to door 20 at opposite ends of support shaft 144 by shaft support bearings 143a, 143b. Support bearings 143a, 143b are mounted to vertical stiles 136a, 136b which reinforce the structural integrity of door 120 generally and hollow door section 131 in particular. Cable drums 146a, 146b are substantially aligned with vertical stiles 136a, 136b of hollow door section 131. In this case, a length of each tensioning member 150a, 150b is wound at one end about its respective cable drum 146a, 146b. Each tensioning member 150a, 150b then extends downward to pulleys 160a, 160b which are mounted to the bottom of hollow door section 131 below each cable drum 146a, 146b, and then to the inner races 152a, 152b of dual race cable drums 147a, 147b about which the opposite ends of tensioning members 150a, 150b are wound. A second pair of tensioning members 151a, 151b are partially wound about the outer races 153a, 153b of dual race cable drums 147a, 147b and run to the lowermost corners of hollow door section 131 where they pass through pulleys 170a, 170b and are then redirected out of door 120 through apertures 133a, 133b and upward to a fixed points 180a, 180b above the doorway. The diameter of outer race 153a, 153b may vary relative to the diameter of inner race 152a, 152b of each dual race cable drum 147a, 147b to adjust overall tension and to provide a mechanical advantage. A preferred ratio of diameters of outer race 153a, 153b to inner race 152a, 152b is 4:1, although any diameter of outer race 153a, 153b which is greater than the diameter of inner race 152a, 152b will provide a desired mechanical advantage. Although tensioning members 150a, 150b and 151a, 151b are described herein as cables, it will be appreciated by those skilled in the art that other forms of tensioning members 150a, 150b and 151a, 151b may alternatively be used including, for example, cords, ropes, belts, chains, and the like.

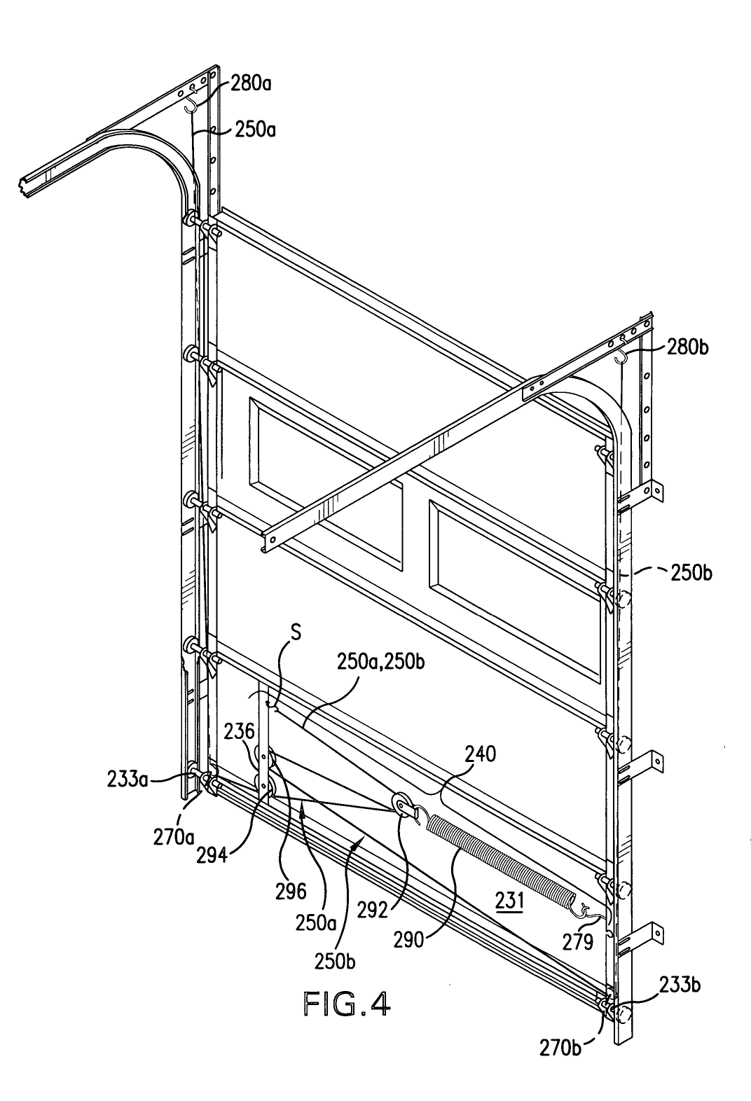

As shown in FIG. 4, yet another counterbalancing mechanism 240 includes a relatively horizontal torsion spring 290 within hollow door section 231 and removably attached at one end to a fixed location therein via spring attachment means 279. Spring attachment means 279, herein depicted as a hook, may of course take numerous other forms. Dual pulley 292 is attached by conventional means to the other end of torsion spring 290 which said end is free-floating and supported only by tensioning members 250a,250b as described below. A pair of tensioning members 250a,250b share a common point of origin along the length of vertical stile 236 to which they are anchored using an S-hook or other suitable means. Tensioning members 250a,250b together are threaded through dual pulley 292. Tensioning member 250a is then directed through optional first stile pulley 294, which is rotatably mounted at a second point along the length of vertical stile 236, and thereafter through corner pulley 270a, out of door section 231 via aperture 233a, and then upward to fixed point 280a above door 220. In like fashion, tensioning member 250b emerges from dual pulley 292 and is then threaded through second stile pulley 296, which is rotatably mounted at a third point along the length of vertical stile 236, and thereafter through corner pulley 270b, out of door section 231 via aperture 233b, and then upward to fixed point 280b above door 220.

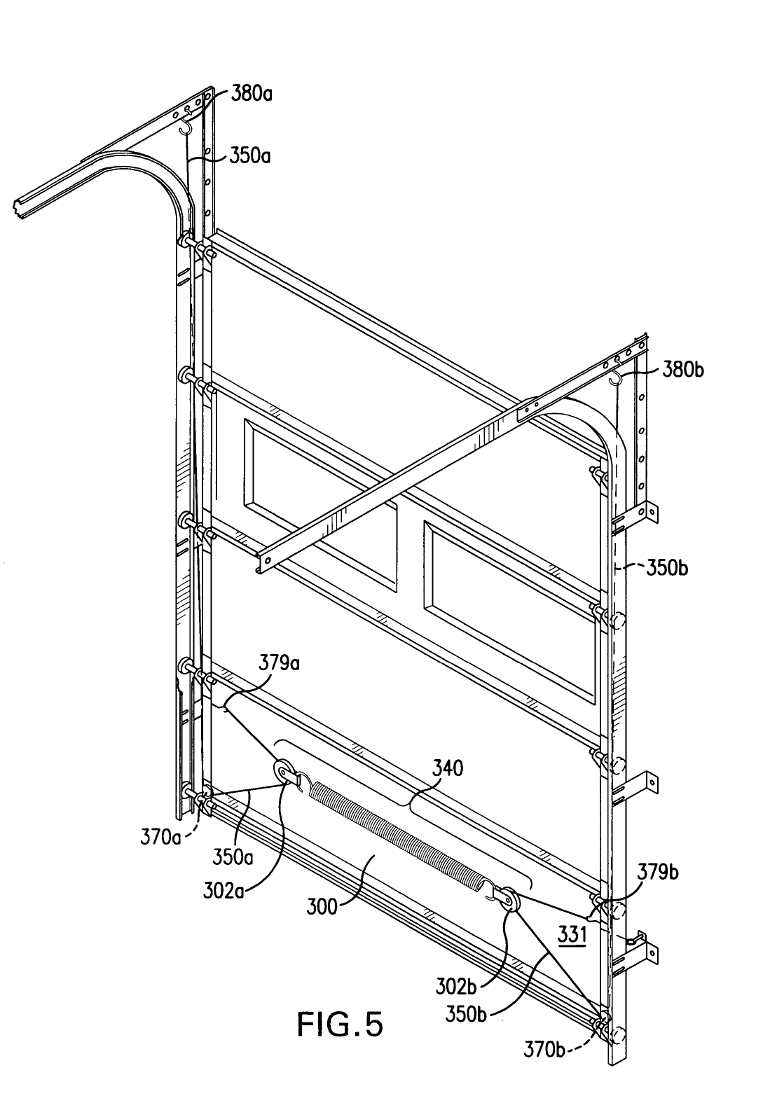

As shown in FIG. 5, another counterbalancing mechanism 340 a relatively horizontal torsion spring 300 with pulleys 302a, 302b attached at either end and free-floating and suspended within hollow door section 331. Pulleys 302a, 302b are herein depicted as attached to torsion spring 300 by means of a hook, but, the attachment means may, of course, take numerous other forms. A pair of tensioning members 350a,350b originate attachment points 379a, 379b located along the interior sides 326a, 326b of hollow door section 331 to which they are anchored using an S-hook or other suitable means. Tensioning members 350a, 350b could alternatively anchored to vertical stiles or other suitably secure point within hollow door section 331. Tensioning members 350a, 350b are threaded through pulleys 302a, 302b and thereafter to pulleys 370a, 370b, out of the hollow door section 331 via aperture 333a, 333b to fixed points 380a, 381b above door 320.

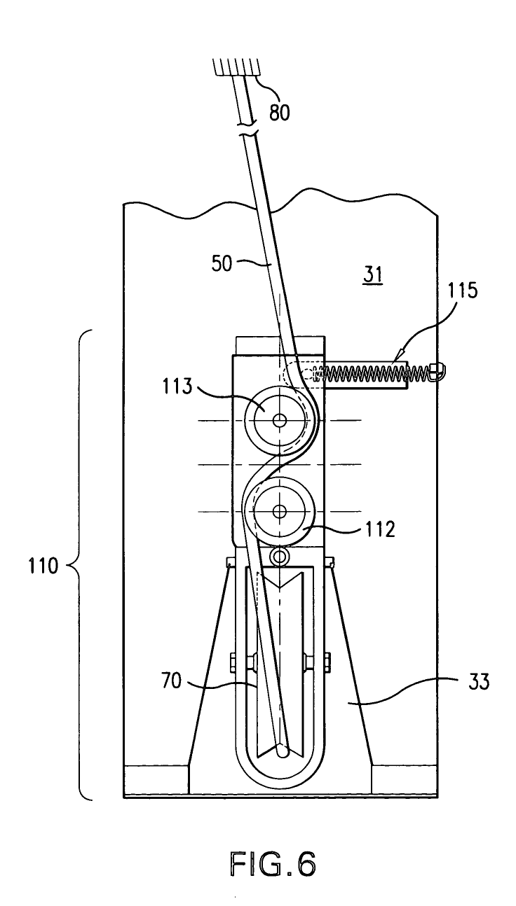

As shown in FIG. 6, depicting a side view of the lower corner of hollow door section 31, the change in direction of the tensioning member 50 as it passes out of hollow door section 31 through aperture 33 may be accomplished through an idler cam 110. As described above tensioning member 50 passes around pulley 70 out of aperture 33 to fixed point 80. Tension on tensioning member 50 provided by spring 115 will cause the idler cam to pivot in accordance with the linear path of the cable and absorbs any slackening of tension on the cables. This provides a smooth transfer of direction from pulley 70 to pulley 112 to pulley 113.

Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. In addition to the variations described herein, other known equivalents for each feature can be mixed and matched by one of ordinary skill in this art to construct various components of the invention.

Although this invention has been disclosed in the context of certain preferred embodiments and examples, it therefore will be understood by those skilled in the aft that the present invention extends beyond the specifically disclosed embodiments and/or uses of the invention and obvious modifications and equivalents thereof. Thus, it is intended that the scope of the present invention herein disclosed should not be limited by the particular disclosed embodiments described above, but should be determined only be a fair reading of the claims that follow.

1. A vertically moveable door apparatus, comprising: a door and a counterbalance mechanism, said door having a hollowed area; said counterbalance mechanism being mounted within said hollowed area and connected to at least one fixed point above said door; whereby said counterbalance mechanism counteracts the effect of gravity on said door and facilitates movement of said door between open and closed positions.

2. A counterbalanced vertically moveable door assembly for mounting within a pair of conventional guide tracks which are fixedly mounted on the sides of a doorway, the door assembly comprising:
a) a door having a hollowed area capable of receiving therein a counterbalance mechanism; and
b) a counterbalance mechanism mounted within said hollowed area of said door, said counterbalance mechanism including at least one tensioning member connected to at least one fixed point above said door,
whereby said counterbalance mechanism counteracts the effect of gravity on said door and facilitates movement of said door between open and closed positions.

3. A counterbalanced vertically moveable door assembly for mounting within a pair of conventional guide tracks which are fixedly mounted on the sides of a doorway, the door assembly comprising:
a) a door; said door being comprised of a plurality of door sections hingedly attached in series, one on top of another; at least one of said plurality of door sections having a hollowed area capable of receiving therein a counterbalance mechanism; and
b) a counterbalance mechanism mounted within said hollowed area of said at least one door section, said counterbalance mechanism including at least one tensioning member connected to at least one fixed point above said door,
whereby said counterbalance mechanism counteracts the effect of gravity on said door and facilitates movement of said door between open and closed positions.
